(19) United States
(12) Patent Application Publication
(10) Pub. No.: US 2008/0073614 A1
(43) Pub. Date: Mar. 27, 2008

(54) Metal removing solution and metal removing method using the same

(75) Inventors: Daisaku Akiyama, Hyogo (JP); Daisuke Katayama, Hyogo (JP)

Correspondence Address: HAMRE, SCHUMANN, MUELLER & LARSON, P.C., P.O. BOX 2902, MINNEAPOLIS, MN, 55402-0902, US

(73) Assignee: MEC COMPANY LTD., HYOGO (JP)

(21) Appl. No.: 11/903,837

(22) Filed: Sep. 25, 2007

(30) Foreign Application Priority Data
Sep. 25, 2006 (JP) 2006-259126

(51) Int. Cl. C09K 13/08

(52) U.S. Cl. 252/79.3; 252/79.4

(57) ABSTRACT

A metal removing solution of the present invention is a solution for removing palladium, tin, silver, palladium alloy, silver alloy, and tin alloy, and the metal removing solution contains a chain thiocarbonyl compound. A removing method of the present invention for removing palladium, tin, silver, palladium alloy, silver alloy, and tin alloy is a method for selectively removing a metal other than copper or copper alloy, from a system that includes copper or copper alloy and at least one selected from palladium, tin, silver, palladium alloy, silver alloy, and tin alloy, by using a metal removing solution containing a chain thiocarbonyl compound. Thus, the present invention provides the metal removing solution capable of removing palladium, tin, silver, palladium alloy, silver alloy, and tin alloy, the solution having an excellent property of removing palladium, tin, silver, palladium alloy, silver alloy, tin alloy, and the like without attacking copper, and having an excellent handleability since the solution does not contain any toxic substance; and the removing method using the foregoing metal removing solution.

### BACKGROUND OF THE INVENTION

1. Field of the Invention

The present invention relates to a metal removing solution that can remove palladium, tin, silver, palladium alloy, silver alloy, and tin alloy, and also relates to a metal removing method using the same.

2. Description of Related Art

In the production of an electronic substrate such as a printed wiring board or the like, a “semi-additive method” has been adopted for a part of the production of the high precision wiring. According to the semi-additive method, a conductive circuit is formed in the following manner. First, catalyst particles made of palladium, silver, or the like are adhered to an insulating material made of resin or the like so as to serve as a plating catalyst nuclei. By using the plating catalyst nuclei, an electroless copper plating layer that serves as a power supplying layer is formed. Next, a photoresist layer is formed on an entire surface, which then is subjected to an exposure process and a development process successively, whereby a plating resist is provided on a portion other than a portion where a copper wiring will be formed. Then, a portion where the plating resist is not provided is subjected to electrolytic copper plating, so that the copper wiring is formed on the power supplying layer, and thereafter, the plating resist and an unwanted portion of the power supplying layer are removed.

In the course of this method, some of the catalyst particles remain on a surface from which the power supplying layer is removed by etching. If an electroless plating of nickel or gold for a finishing process further is provided to the surface in this state, some metals may be deposited on an insulator, thereby increasing the risk of providing poor insulation between circuits. Therefore, it is necessary to remove the residual catalyst.

While the catalyst particles sometimes remain on the insulating material, the catalyst particles also sometimes adhere to a surface of a conductor in the course of the production process. The unwanted palladium thus adhering to the surface of the conductor will adversely affect post-treatment. Therefore, such particles should also be removed.

Furthermore, a palladium-tin colloidal catalyst solution has been used as a plating catalyst. In this case, tin as well as palladium remains on the surface of the insulating material. Therefore, the property of removing tin also is required.

Examples of conventional removers for removing such a residual palladium catalyst include the following: a remover containing a fluoroboric acid-based compound, proposed by Patent Document 1; a remover containing a cyanide-based compound, proposed by Patent Document 2; removers containing a nitric acid-based compound, proposed by Patent Documents 3 and 4; and a remover containing a sulfur-containing organic compound such as cyclic thion, proposed by Patent Document 5.

The above-mentioned conventional art has problems as described below. With use of the fluoroboric acid-based remover of Patent Document 1 or the cyanide-based remover of Patent Document 2 for removing palladium, copper is attacked as well while palladium is attacked. Moreover, it is difficult to dispose of liquid wastes that contain toxic substances such as hydrofluoric acid and cyanides. The use of the nitric acid-based palladium remover of Patent Document 3 or 4 may generate NOₓ, which possibly attacks copper. In the case of the sulfur-containing organic compound such as a cyclic thiocarbonyl of Patent Document 5, copper is less likely attacked and the handling thereof is easy because no toxic substance is used. However, the low solubility of this compound makes it difficult for a palladium removing solution to dissolve a sufficient amount of active components of the compound, resulting in the poor performance in removing palladium. Similarly, other cyclic thiocarbonyls such as 2-thiouracil and 2-thiobarbituric acid, 2-thioxanthine, 2-thiocoumarin, thiobarbital (soluble in heated water), and cyclohexanethion have the problem of low solubility.

Patent Documents 6 to 13 show typical conventional removers used for removing tin. The remover disclosed in Patent Document 6 contains pyrophosphoric acid and phosphorous acid, which place a great burden on the environment. The removers disclosed in Patent Documents 7 and 8 are nitric acid-based removers. The removers disclosed in Patent Documents 9 and 10 contain hydrogen peroxide. The conventional art as described above has a problem that copper is attacked as well while tin is attacked. The remover disclosed in Patent Document 11 has nitrobenzenesulfonic acid as a main component, which tends to form sludge in an etching solution. The remover disclosed in Patent Document 12, which contains fluorine as a main component, requires laborious and costly process for disposing of liquid wastes that contain fluorine. The remover disclosed in Patent Document 13 is a remover containing stannous ion. Since it contains stannous ion in high concentration, there is a possibility that stannous hydroxide or the like is deposited on a surface of a treated substrate when the treated substrate is rinsed with water after the treatment.

Patent Document 1: JP 63 (1988)-72198 A

Patent Document 2: JP 07 (1995)-207466 A

Patent Document 3: WO 02/008491

Patent Document 4: JP 2001-339142 A

Patent Document 5: JP 2002-69656 A

Patent Document 6: JP 58 (1983)-193372 A

Patent Document 7: JP 07 (1995)-278846 A

Patent Document 8: JP 11 (1999)-158660 A

Patent Document 9: JP 61 (1986)-159580 A

Patent Document 10: JP 02 (1990)-274825 A

Patent Document 11: JP 01 (1989)-129491 A

Patent Document 12: JP 59 (1984)-74281 A

Patent Document 13: JP 2002-129359 A

### SUMMARY OF THE INVENTION

In order to solve the above-described conventional problems, it is an object of the present invention to provide a metal removing solution that can selectively remove palladium, tin, silver, palladium alloy, silver alloy, and tin alloy. The metal removing solution has an excellent property of removing palladium, tin, silver, palladium alloy, silver alloy, tin alloy and the like without attacking copper, and has excellent handleability since it does not contain any toxic substance. It is also an object of the present invention to provide a metal removing method using the foregoing metal removing solution.

The metal removing solution of the present invention is a solution for removing palladium, tin, silver, palladium alloy, silver alloy and tin alloy, and containing a chain thiocarbonyl compound.

The metal removing method of the present invention is a method for selectively removing palladium, tin, silver, palladium alloy, silver alloy and tin alloy from a system by using a metal removing solution containing a chain thiocarbonyl compound, the system including copper or copper alloy, and at least one metal selected from palladium, tin, silver, palladium alloy, silver alloy, and tin alloy.

### BRIEF DESCRIPTION OF THE DRAWINGS

FIG. 1 is a graph showing data obtained from Example 9 of the present invention, for comparing etching rates with respect to Cu between solutions of Example 6 and Comparative Example 4.

### DETAILED DESCRIPTION OF THE INVENTION

With the metal removing solution of the present invention and the metal removing method of the present invention using the foregoing metal removing solution, the following can be achieved: an excellent property of selectively removing palladium, tin, silver, palladium alloy, silver alloy, and tin alloy without attacking copper; and excellent handleability because of the foregoing solution not containing any toxic substance. When an acid is contained additionally, the solution can promote oxidative dissolution of palladium, tin, silver, palladium alloy, silver alloy, and tin alloy. Therefore, a further excellent removing property can be obtained. When a halogen ion is contained additionally, the solution can hold removed palladium, tin, silver, palladium alloy, silver alloy or tin alloy stably. Therefore, the removal of these metals can be accelerated.

The metal remover of the present invention is useful not only for removing plating catalyst residues but also for removing, for example, a thin film of tin plating provided on a surface of copper while minimizing any possible damage to an underlying copper layer.

The present invention is particularly useful in the following case: when electroless copper plating is performed with respect to an insulating material of an electronic substrate such as a printed wiring board by adhering palladium particles, silver particles, or palladium-tin particles to the insulation material so that the particles serve as catalyst nuclei, the present invention is useful in a subsequent step of removing the particles therefrom by etching.

The metal remover of the present invention has a property of selectively removing palladium, tin, silver, palladium alloy, silver alloy, tin alloy, and the like without attacking copper. Suitable conditions for using the metal remover are, for example, a solution temperature of 10 to 70° C., preferably 20 to 50° C., an application time of 10 to 300 seconds, preferably 15 to 120 seconds. Under such conditions, a more excellent property of selective etching can be exhibited.

As an application method, either spraying or immersion may be used. In the case of spraying, a spraying pressure is 0.01 to 0.4 MPa, preferably 0.05 to 0.2 MPa.

For forming the metal remover of the present invention, the following components as described below, for example, can be used, though the components are not limited particularly:

(1) chain thiocarbonyl compound

(2) acid

(3) halogen ion

### 1. Chain Thiocarbonyl Compound

Examples of thiocarbonyl compounds include a thiocarbonyl compound having a thiocarbonyl group (>C═S) in which carbon is bonded in a chain structure (chain thiocarbonyl compound), and a thiocarbonyl compound having a thiocarbonyl group in which carbon is bonded in a cyclic structure. The compound having a cyclic structure is described in the above “Description of Related Art” section, being referred to as “cyclic thiocarbonyl compound”.

The chain thiocarbonyl compound is used in the present invention. This compound is a chain-form compound having a >C═S bond, in which the thiocarbonyl group (>C═S) is not included in a cyclic structure. Examples of the compound include thiourea compound, thiuram compound, dithiocarbamic acid compound, xanthogenic acid compound, ethyl methyl thioketone, 2,4-pentanedithione, 2-thioxo-4-thiazolidinone (Rhodanine), 2-thiouracil, and thioacetamide.

(1) Examples of thiourea compound: 1-acetyl-2-thiourea, 1-allyl-3-(2-hydroxyethyl)-2-thiourea, 1-amidino-2-thiourea, 1,3-diethylthiourea, 1,3-diphenylthiourea, 1,3-dibutylthiourea, 1,3-dimethylthiourea, thiourea, tributylthiourea, trimethylthiourea, 1,3-bis(dimethylaminopropyl)-2-thiourea, tetramethylthiourea, and N-methylthiourea.
(2) Examples of thiuram compound: tetramethylthiuram disulfide, tetraethylthiuram disulfide, and tetrabutylthiuram disulfide.
(3) Examples of dithiocarbamic acid compound: 2-(N,N′-diethylthiocarbamoylthio)benzothiazole, zinc dimethyldithiocarbamate, nickel diethyldithiocarbamate, nickel dibutyldithiocarbamate, and sodium dibutyldithiocarbamate.
(4) Examples of xanthogenic acid compound: zinc butylxanthate, and isopropylxanthogenic acid.

Thiourea compounds such as thiourea, tetramethylthiourea, N-methylthiourea, 1,3-diethylthiourea, and 1,3-dimethylthiourea are preferred particularly, owing to their excellent properties of removing palladium, tin and silver.

The chain thiocarbonyl compound is mixed so that the content thereof is, preferably, not less than 0.05 wt % and not more than 80 wt %, and more preferably, not less than 0.1 wt % and not more than 40 wt %. The efficiency for removing palladium, tin and silver decreases slightly when the content of the compound is less than 0.1 wt %. When the content of the compound is less than 0.05 wt %, the remover tends to be incapable of removing palladium, tin and silver sufficiently.

### 2. Acid

An acid is mixed in order to promote the oxidization of palladium, tin and silver, thereby improving the solubility. Examples of acids that can be used in the present invention include sulfonic acid compounds such as methanesulfonic acid, benzenesulfonic acid, p-toluenesulfonic acid, and taurine; inorganic acids such as hydrochloric acid, sulfuric acid, nitric acid, fluoroboric acid, and phosphoric acid; and carboxylic acids such as formic acid, acetic acid, propionic acid, and butyric acid. Among these acids, a hydrochloric acid preferably is used because a halogen ion, which will be described below, can be added at the same time. The concentration of an acid is preferably in a range of 0.001 wt % to 0.7 wt %, both inclusive, in terms of H⁺ (hereafter concentrations are presented in the same manner), more preferably 0.1 wt % to 0.7 wt %, both inclusive, and particularly preferably 0.5 wt % to 0.7 wt %, both inclusive. There is no disadvantage in mixing an acid in a large amount. However, if, for example, hydrochloric acid is used as acid, the compound is not easily dissolved in water when the used amount of the same exceeds 0.7 wt %. On the other hand, when the content of an acid is less than 0.001 wt %, the property of removing palladium, tin and silver tends to degrade.

### 3. Halogen Ion

A halogen ion is mixed so as to keep the removed palladium, tin and silver stably in the solution. An ion source for the halogen ion is not limited particularly. Examples of the same include hydrochloric acid and salts such as sodium chloride, ammonium chloride, calcium chloride, potassium chloride, potassium bromide, sodium fluoride and potassium iodide.

The concentration of a halogen ion is in a range of, preferably not less than 0.03 wt % and not more than 30 wt %, more preferably not less than 1 wt % and not more than 30 wt %, and particularly preferably not less than 7 wt % and not more than 30 wt %. Stable dissolution of palladium, tin and silver in a solution is not likely to be achieved if the concentration of the halogen ion is less than 0.03 wt %.

Moreover, if hydrochloric acid is mixed as the above-mentioned acid, the addition of a halogen ion can be achieved simultaneously.

### 4. Other Additives

Other additives such as a surface-active agent and a stabilizer may be added appropriately to the metal remover of the present invention as required.

### EXAMPLES

Hereinafter, the present invention will be described more specifically by way of Examples. It should be noted that the invention is not limited to the following examples. In the following, “%” means “percent by weight”.

### Examples 1 to 7 and Comparative Examples 1 to 3

### 1. A Test to Evaluate the Property of Removing Palladium

### A Method for Producing a Pd Applied Plate

A substrate made of a glass epoxy resin having a thickness of 0.2 mm, a length of 10 cm and a width of 10 cm was treated as follows, whereby a Pd applied plate was produced.

(1) The substrate was immersed in a preconditioner (PIW-1 produced by Okuno Chemical Industries Co., Ltd.) at 45° C. for 2 minutes, rinsed with water, and thereafter, immersed in an ATS CONDICLEAN (CIW-1 produced by Okuno Chemical Industries Co., Ltd.) at 65° C. for 5 minutes, whereby the resin substrate was roughened.

### (2) The substrate thus treated was immersed in a pre-dipping agent (OPC-SALH produced by Okuno Chemical Industries Co., Ltd.) at 25° C. for 2 minutes, whereby the resin substrate was subjected to neutralization.

(3) The substrate was then immersed in a catalyst (OPC-SALH produced by Okuno Chemical Industries Co., Ltd. and OPC-80 produced by the same) at 25° C. for 15 minutes, rinsed with water, and thereafter, immersed in an accelerator (OPC-505A produced by Okuno Chemical Industries Co., Ltd. and OPC-505B produced by the same) at 35° C. for 5 minutes, then, rinsed with water and dried, whereby a Pd catalyst was adhered. An amount of Pd in the Pd applied plate thus obtained was 19.1 mg/m².

### Example 8 and Comparative Example 4

A Pd applied plate formed with a copper substrate to which palladium was applied was produced in the same manner as that for Examples 1 to 7 and Comparative Examples 1 to 3 described above except that a copper substrate (product name: MCL-E-679 having a thickness of 0.2 mm, produced by Hitachi Chemical Co., Ltd.) was used in place of the glass epoxy resin substrate. Plates thus formed were used in Example 8 and Comparative Example 4.

The Pd applied plates thus produced were immersed in solutions having components formulated as shown in Tables 1 to 3 (the remainder is ion-exchanged water), under temperature and time conditions shown in Tables 1 to 3. Then, the remaining Pd was measured. The removal efficiencies thus determined are shown in Tables 1 to 3.

TABLE 1

| Formulation | Untreated plate | Example 1 | Example 2 | Example 3 | Example 4 |
|---|---|---|---|---|---|
| Chain thiocarbonyl compound | | DMTU | DMTU | DMTU | Thiourea |
| | | 50 wt % | 0.05 wt % | 6 wt % | 7 wt % |
| NaCl | | | | 10 wt % | |
| 62.5% H₂SO₄ | | | | | 70 wt % |
| Treatment condition | | 50° C., 60 sec. | 50° C., 60 sec. | \textcircled{1}50° C., 180 sec. | \textcircled{1}50° C., 60 sec. |
| | | | | \textcircled{2}50° C., 60 sec. | \textcircled{2}50° C., 120 sec. |
| Pd (mg/m²) | 19.1 | 6.1 | 10.6 | \textcircled{1}4.0 | \textcircled{1}1.3 |
| | | | | \textcircled{2}6.5 | \textcircled{2}1.2 |
| Removal efficiency (%) | | 68.2 | 44.5 | \textcircled{1}78.9 | \textcircled{1}93.3 |
| | | | | \textcircled{2}65.6 | \textcircled{2}93.8 |

DMTU: 1,3-dimethylthiourea

TABLE 2

| Formulation | Example 5 | Example 6 | Example 7 | Example 8 |
|---|---|---|---|---|
| Chain thiocarbonyl | Tetramethylthiourea | TMU | N-methylthiourea | EUR |
| compound | 1 wt % | 4 wt % | 3 wt % | 4 wt % |
| 35% HCl | | 60 wt % | 60 wt % | 60 wt % |
| Methanesulfonic acid | 60 wt % | | | |
| Treatment condition | \textcircled{1}50° C., 180 sec. | \textcircled{1}25° C., 600 sec. | \textcircled{1}45° C., 120 sec. | \textcircled{1}50° C., 10 sec. |
| | \textcircled{2}60° C., 60 sec. | \textcircled{2}60° C., 30 sec. | \textcircled{2}60° C., 120 sec. | \textcircled{2}50° C., 30 sec. |
| | \textcircled{3}50° C., 60 sec. | \textcircled{3}60° C., 60 sec. | \textcircled{3}50° C., 60 sec. | \textcircled{3}50° C., 60 sec. |
| | | \textcircled{4}50° C., 60 sec. | | |
| Pd (mg/m²) | \textcircled{1}1.7 | \textcircled{1}0 | \textcircled{1}1.2 | \textcircled{1}1.2 |
| | \textcircled{2}1.8 | \textcircled{2}1.2 | \textcircled{2}1.8 | \textcircled{2}1.0 |
| | \textcircled{3}2.1 | \textcircled{3}0.9 | \textcircled{3}0.8 | \textcircled{3}0.8 |
| | | \textcircled{4}0.7 | | |
| Removal | \textcircled{1}91.2 | \textcircled{1}100 | \textcircled{1}89.9 | \textcircled{1}93.6 |
| efficiency (%) | \textcircled{2}90.6 | \textcircled{2}93.6 | \textcircled{2}90.7 | \textcircled{2}94.7 |
| | \textcircled{3}89.2 | \textcircled{3}95.4 | \textcircled{3}96.1 | \textcircled{3}95.6 |
| | | \textcircled{4}96.3 | | |

TMU: trimethylthiourea
EUR: 1,3-diethylthiourea

TABLE 3

| Formulation | Comp. Ex. 1 | Comp. Ex. 2 | Comp. Ex. 3 | Comp. Ex. 4 |
|---|---|---|---|---|
| Thiocarbonyl | 2-thiouracil | 2-thiobarbituric acid | 2-thiobarbituric acid | |
| compound | 0.03 wt % | 0.05 wt % | 0.05 wt % | |
| NaCl | | 10 wt % | | |
| 35% HCl | | | | 8 wt % |
| 62.5% H₂SO₄ | | | 70 wt % | |
| 65% HNO₃ | | | | 20 wt % |
| Treatment condition | 50° C., 60 sec. | 50° C., 60 sec. | 50° C., 60 sec. | \textcircled{1}50° C., 10 sec. |
| | | | | \textcircled{2}50° C., 30 sec. |
| | | | | \textcircled{3}50° C., 60 sec. |
| Pd (mg/m²) | 14.2 | 12.5 | 15.2 | \textcircled{1}18.7 |
| | | | | \textcircled{2}17.8 |
| | | | | \textcircled{3}13.6 |
| Removal efficiency (%) | 25.9 | 34.6 | 20.4 | \textcircled{1}1.9 |
| | | | | \textcircled{2}6.6 |
| | | | | \textcircled{3}28.6 |

As can be seen from Tables 1 to 3, whether palladium was adhered to the resin plate or to the copper plate, higher removal efficiencies with respect to palladium were exhibited in Examples 1 to 8 as compared with those exhibited in Comparative Examples 1 to 4.

Moreover, in the case where an acid and/or halogen ion was present in addition to a chain thiocarbonyl compound, an even higher removal efficiency with respect to palladium was exhibited as compared to the case where a chain thiocarbonyl compound was used alone.

### Example 9

In this Example, a test to evaluate the etching rate with respect to copper was conducted. A solution according to the formulation of Example 6, and a solution according to the formulation of Comparative Example 4, i.e., a solution obtained by blending 8 wt % of 35 wt % HCl, 20 wt % of 65 wt % HNO₃, and the ion-exchanged water as the remainder, were prepared, and the etching rates with respect to copper exhibited by these solutions were compared.

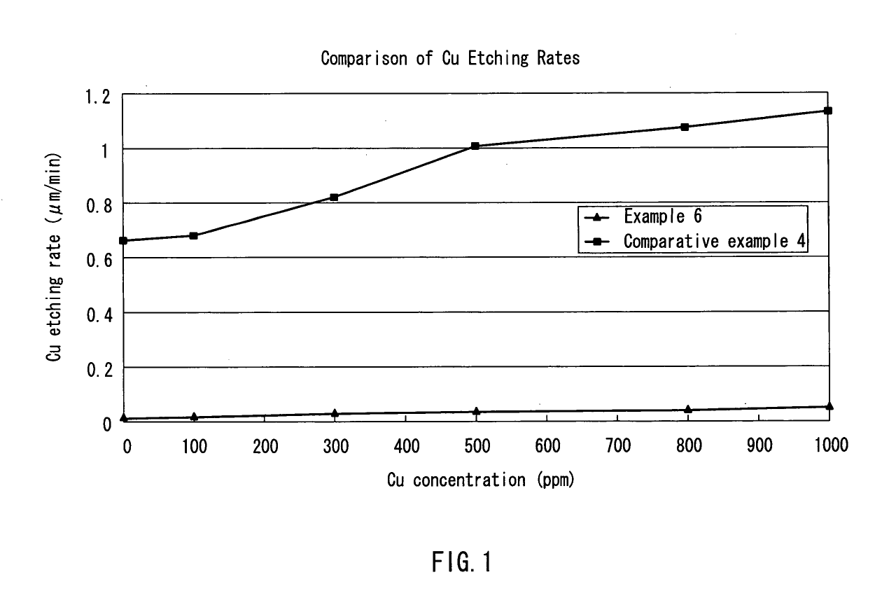

A copper plate (product name: MCL-E-679 having a thickness of 0.2 mm, a length of 4 mm, and a width of 4 mm, produced by Hitachi Chemical Co., Ltd.) was immersed in each of 100 ml solutions for one minute, and the etching rate was measured based on a change in the weight of the copper plate. The etching rate was measured at predetermined levels of the copper concentration, and the results thereof are shown in FIG. 1. The reason why the etching rate was measured at predetermined levels of the copper concentration is that as a copper plate is treated continuously, the copper concentration in the solution increases, and the copper etching rate increases further.

In the case of the solution of Comparative Example 4, the etching rate with respect to copper increased as the concentration of copper increased, in other words, in a state in which palladium was removed continuously. On the other hand, in the case of the solution of Example 6, the etching rate remained low, which means that the attack against copper was suppressed.

### Examples 10 to 14

In these Examples, a test to evaluate the property of removing tin was carried out. A tin plate (having a thickness of 0.2 mm, a length of 4 mm, and a width of 4 mm, Japan Metal Service, Ltd. (distributor)) was immersed in each of 100 ml solutions of Examples 10 to 14 shown in Table 4, at 40° C. for one minute, and the etching rate was measured based on a change in the weight of the tin plate.

### Comparative Examples 5 to 7

In these Comparative Examples also, a test to evaluate the property of removing tin was carried out. A copper plate (product name: MCL-E-679 having a thickness of 0.2 mm, a length of 4 mm and a width of 4 mm, produced by Hitachi Chemical Co., Ltd.) was immersed in each of 100 ml solutions of Comparative Examples 5 to 7 shown in Table 4, at 40° C. for one minute, and the etching rate was measured based on a change in the weight of the copper plate.

Table 4 shows conditions and results of the tests in Examples 10 to 14 and Comparative Examples 5 to 7 altogether.

TABLE 4

| Formulation | Ex. 10 | Ex. 11 | Ex. 12 | Ex. 13 | Ex. 14 | Comp. Ex. 5 | Comp. Ex. 6 | Comp. Ex. 7 |
|---|---|---|---|---|---|---|---|---|
| Thiocarbonyl | Thiourea | TMU⁽*¹⁾ | N-methylthiourea | EUR⁽*²⁾ | Thiourea | 2-thiouracil | 2-thiobarbituric | 2-thiobarbituric |
| compound | | | | | | | acid | acid |
| Amount | 7 | 4 | 3 | 4 | 3 | 0.03 | 0.05 | 0.05 |
| (wt %) | | | | | | | | |
| 35 wt % HCl | — | 60 | 60 | 60 | — | — | — | — |
| 62.5 wt % | 70 | — | — | — | — | — | — | — |
| H₂SO₄ | | | | | | | | |
| 24 wt % | — | — | — | — | 20 | — | — | — |
| NaOH | | | | | | | | |
| Sn | 0.79 | 0.38 | 0.27 | 0.52 | 0.20 | 0.02 | 0.03 | 0.10 |
| (μm/min) | | | | | | | | |
| Cu | 0.02 | 0.00 | 0.00 | 0.00 | 0.00 | 0.00 | 0.00 | 0.00 |
| (μm/min) | | | | | | | | |

⁽*¹⁾TMU: trimethylthiourea
⁽*²) EUR: 1,3-diethylthiourea

As can be seen from Table 4, each solution of Examples 10 to 14 exhibited a high etching rate (0.20 to 0.79 μm/min) with respect to tin, but a low etching rate (0 to 0.02 μm/min) with respect to copper. This means that each solution of these Examples can etch tin selectively, without etching copper.

### Examples 15 to 18

In these Examples, the removal efficiency with respect to silver was evaluated. A substrate made of a glass epoxy resin having a thickness of 0.2 mm, a length of 10 cm and a width of 10 cm was treated as follows, whereby a test plate was produced.

(1) The substrate was immersed in a preconditioner (PIW-1 produced by Okuno Chemical Industries Co., Ltd.) at 45° C. for 2 minutes, rinsed with water, and thereafter, immersed in an ATS CONDICLEAN (CIW-1 produced by Okuno Chemical Industries Co., Ltd.) at 65° C. for 5 minutes, whereby the resin substrate was roughened.

### (2) The substrate thus treated was immersed in a pre-dipping agent (OPC-SALH produced by Okuno Chemical Industries Co., Ltd.) at 25° C. for 2 minutes, whereby the resin substrate was subjected to neutralization.

(3) The substrate thus treated was immersed in a catalyst (OPC-SALH produced by Okuno Chemical Industries Co., Ltd. and OPC-80 produced by the same) at 25° C. for 15 minutes, rinsed with water, and thereafter, immersed in an accelerator (OPC-505A produced by Okuno Chemical Industries Co., Ltd. and OPC-505B produced by the same) at 35° C. for 5 minutes, rinsed with water and dried, whereby a Pd catalyst was adhered to the substrate.
(4) The substrate thus treated was immersed in an electroless silver plating solution (containing silver nitrate, Rochelle salt, ammonia, and sodium hydroxide) at 25° C. for 10 minutes, rinsed with water and dried, whereby silver was deposited on a surface of the resin base material.

The test plates thus produced were immersed in solutions having components that were formulated as shown in Tables 5 and 6 (the remainder is ion-exchanged water), under temperature and time conditions shown in Tables 5 and 6. Then, remaining silver was measured. The removal efficiencies thus determined are shown in Tables 5 and 6.

TABLE 5

| Formulation | Untreated plate | Ex. 15 | Ex. 16 | Ex. 17 | Ex. 18 |
|---|---|---|---|---|---|
| Chain thiocarbonyl | | EUR | TMU | DMTU | N-methylthiourea |
| compound (wt %) | | 35 wt % | 0.05 wt % | 0.5 wt % | 1.0 wt % |
| NaCl | | 10 wt % | 5 wt % | | |
| 35% HCl | | | | 60 wt % | |
| 62.5% H₂SO₄ | | | 60 wt % | | 60 wt % |
| Treatment condition | | \textcircled{1}50° C., 60 sec. | \textcircled{1}50° C., 60 sec. | \textcircled{1}50° C., 60 sec. | \textcircled{1}50° C., 60 sec. |
| | | \textcircled{2}50° C., 120 sec. | \textcircled{2}50° C., 120 sec. | \textcircled{2}50° C., 120 sec. | \textcircled{2}50° C., 120 sec. |
| | | \textcircled{3}50° C., 180 sec. | | | \textcircled{3}50° C., 180 sec. |
| Ag (mg/m²) | 2300 | \textcircled{1}1860 | \textcircled{1}1230 | \textcircled{1}821 | \textcircled{1}1770 |
| | | \textcircled{2}1490 | \textcircled{2}850 | \textcircled{2}559 | \textcircled{2}1430 |
| | | \textcircled{3}1140 | | | \textcircled{3}1260 |
| Removal | | \textcircled{1}19.1 | \textcircled{1}46.5 | \textcircled{1}64.3 | \textcircled{1}23.0 |
| efficiency (%) | | \textcircled{2}35.2 | \textcircled{2}63.0 | \textcircled{2}75.7 | \textcircled{2}37.8 |
| | | \textcircled{3}50.4 | | | \textcircled{3}45.2 |

EUR: 1,3-diethylthiourea
DMTU: dimethylthiourea

TABLE 6

| Formulation | Comp. Ex. 8 | Comp. Ex. 9 | Comp. Ex. 10 | Comp. Ex. 11 | Comp. Ex. 12 |
|---|---|---|---|---|---|
| Thiocarbonyl | | | 2-thiobarbituric | 2-thiobarbituric | 2-thiouracil |
| compound | | | acid | acid | 5 wt % |
| | | | 0.05 wt % | 0.01 wt % | |
| NaCl | | 10 wt % | | | |
| HCl | | | | 60 wt % | 30 wt % |
| 62.5% H₂SO₄ | 40 wt % | | 60 wt % | | 30 wt % |
| Treatment condition | 50° C., 180 sec. | 50° C., | 50° C., 180 sec. | 50° C., 180 sec. | \textcircled{1}50° C., 60 sec. |
| | | 180 sec. | | | \textcircled{2}50° C., 120 sec. |
| Ag (mg/m²) | 2270 | 2293 | 2080 | 2098 | \textcircled{1}2233 |
| | | | | | \textcircled{2}2109 |
| Removal efficiency (%) | 1.3 | 0.3 | 9.6 | 8.8 | \textcircled{1}2.4 |
| | | | | | \textcircled{2}8.3 |

TMU: trimethylthiourea
DMTU: dimethylthiourea

As can be seen from Tables 5 and 6, high removal efficiencies with respect to silver were exhibited the above-described Examples as compared to those exhibited in Comparative Examples.

### INDUSTRIAL APPLICABILITY

The present invention is useful in the manufacture of an electronic substrate such as a printed wiring board, as well as in the patterning of a transparent conductive film and the wiring for use in a thin-type flat-panel display (e.g. liquid crystal display, plasma display)

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A metal removing solution for removing palladium, tin, silver, palladium alloy, silver alloy and tin alloy comprising:
a chain thiocarbonyl compound.

2. The metal removing solution according to claim 1, wherein a concentration of the chain thiocarbonyl compound in the metal removing solution is not less than 0.05 wt % and not more than 80 wt %.

3. The metal removing solution according to claim 1, wherein the chain thiocarbonyl compound is at least one compound selected from thiourea compound, thiuram compound, dithiocarbamic acid compound, xanthogenic acid compound, ethyl methyl thioketone, 2,4-pentanedithione, 2-thioxo-4-thiazolidinone (Rhodanine), 2-thiouracil, and thioacetamide.

4. The metal removing solution according to claim 1, further comprising at least one selected from a halogen ion and an acid.

5. The metal removing solution according to claim 4, wherein a concentration of the halogen ion in the metal removing solution is not less than 0.03 wt % and not more than 30 wt %.

6. The metal removing solution according to claim 4, wherein an ion source for the halogen ion is at least one selected from hydrochloric acid, sodium chloride, ammonium chloride, calcium chloride, potassium chloride, potassium bromide, sodium fluoride, and potassium iodide.

7. The metal removing solution according to claim 4, wherein a concentration of the acid in the metal removing solution is not less than 0.001 wt % and not more than 0.7 wt % in terms of H⁺.

8. The metal removing solution according to claim 4, wherein the acid is at least one acid selected from methanesulfonic acid, benzenesulfonic acid, p-toluenesulfonic acid, taurine, hydrochloric acid, sulfuric acid, nitric acid, fluoroboric acid, phosphoric acid, formic acid, acetic acid, propionic acid, and butyric acid.

9. A metal removing method comprising:
selectively removing at least one metal selected from palladium, tin, silver, palladium alloy, silver alloy and tin alloy from a system by using a metal removing solution containing a chain thiocarbonyl compound, the system including copper or copper alloy, and at least one metal selected from palladium, tin, silver, palladium alloy, silver alloy, and tin alloy.

10. The metal removing method according to claim 9, wherein a concentration of a chain thiocarbonyl compound in the metal removing solution is not less than 0.05 wt % and not more than 80 wt %.

11. The metal removing method according to claim 9, wherein the chain thiocarbonyl compound is at least one compound selected from thiourea compound, thiuram compound, dithiocarbamic acid compound, xanthogenic acid compound, ethyl methyl thioketone, 2,4-pentanedithione, 2-thioxo-4-thiazolidinone (Rhodanine), 2-thiouracil, and thioacetamide.

12. The metal removing method according to claim 9, wherein the metal removing solution further contains at least one selected from a halogen ion and an acid.

13. The metal removing method according to claim 12, wherein a concentration of the halogen ion in the metal removing solution is not less than 0.03 wt % and not more than 30 wt %.

14. The metal removing method according to claim 12, wherein an ion source for the halogen ion is at least one selected from hydrochloric acid, sodium chloride, ammonium chloride, calcium chloride, potassium chloride, potassium bromide, sodium fluoride, and potassium iodide.

15. The metal removing method according to claim 12, wherein a concentration of the acid in the metal removing solution is not less than 0.001 wt % and not more than 0.7 wt % in terms of H⁺.

16. The metal removing method according to claim 12, wherein the acid is at least one acid selected from methanesulfonic acid, benzenesulfonic acid, p-toluenesulfonic acid, taurine, hydrochloric acid, sulfuric acid, nitric acid, fluoroboric acid, phosphoric acid, formic acid, acetic acid, propionic acid and butyric acid.

17. The metal removing method according to claim 9, wherein the metal to be removed is a residue of a catalyst used for metal plating.

18. The metal removing method according to claim 9, wherein the metal to be removed is a plating film formed on a surface of copper.
